(19) United States
(12) Patent Application Publication
(10) Pub. No.: US 2019/0380364 A1
(43) Pub. Date: Dec. 19, 2019

(54) COATING MATERIAL FOR DEEP-FRIED FOOD

(71) Applicant: NICHIREI FOODS INC., Tokyo-to (JP)

(72) Inventors: Tomoki ABE, Chiba-shi (JP); Masao SAWADA, Chiba-shi (JP)

(73) Assignee: NICHIREI FOODS INC., Tokyo-to (JP)

(21) Appl. No.: 16/489,168

(22) PCT Filed: Feb. 27, 2018
(86) PCT No.: PCT/JP2018/007156

§ 371 Date: Aug. 27, 2019

(30) Foreign Application Priority Data
Feb. 28, 2017 (JP) 2017-037367

(51) Int. Cl. A23L 3/36; A23L 5/10

(52) U.S. Cl. CPC A23L 3/36; A23L 7/157; A23L 5/10

(57) ABSTRACT

A batter for a deep-fried food product, containing a non-gelatinized starch, an emulsifier, an oil or fat, and water, in which a content of the water relative to the non-gelatinized starch is 60 to 100 parts by mass relative to 100 parts by mass of the non-gelatinized starch is disclosed. By using this batter, excellent eating texture of a coating can be maintained in a deep-fried food product.

### REFERENCE TO RELATED APPLICATION

This application claims the benefit of priority from Japanese Patent Application No. 2017-37367 filed on Feb. 28, 2017. The disclosure of this earlier application is incorporated herein by reference in its entirety.

### BACKGROUND OF THE INVENTION

### Technical Field

The present invention relates to a coating material used for a deep-fried food product, and more particularly, to a batter used for the same.

### Background Art

It is an eternal challenge in fried products with a coating to obtain an improved and lasting crispy texture. To overcome this challenge, various coating materials and batters have been developed (Patent Documents 1 to 3).

However, when a food product to be deep-fried coated with a conventional coating material or a batter is deep-fried in an oil and then packed in bags or containers for sale while the deep-fried food product is still warm, the coating material absorbs moisture such as water vapor in the packing container and moisture transferred from a filling after a few hours. Thus, even if the deep-fried food product is eaten as it is or after being heated with a microwave, an eating texture of the coating material is not as good as expected.

### PRIOR ART DOCUMENT

### Patent Document

[Patent Document 1] Japanese Patent Laid-Open No. 9-206016
[Patent Document 2] Japanese Patent Laid-Open No. 7-155127
[Patent Document 3] Japanese Patent Laid-Open No. 2011-244720

### SUMMARY OF THE INVENTION

The present inventors found that by adjusting a mass ratio between water and a non-gelatinized starch in a batter containing a non-gelatinized starch, an emulsifier, an oil or fat, and water to a particular range, the eating texture of a coating material of the deep-fried food product produced by using the batter is prevented from being degraded over time. The present invention was made based on the above finding.

Accordingly, an object of the present invention is to provide a batter capable of providing an excellent and lasting eating texture of a coating of a deep-fried food product, a processed food product for deep-frying containing the batter, and a deep-fried food product produced by using the batter.

The present invention includes the following inventions.

(1) A batter for a deep-fried food product, comprising a non-gelatinized starch, an emulsifier, an oil or fat, and water, wherein a content of the water relative to the non-gelatinized starch is 60 to 100 parts by mass relative to 100 parts by mass of the non-gelatinized starch.
(2) The batter for a deep-fried food product according to the above (1), wherein in a deep-fried food product produced by deep-frying a processed food product for deep-frying containing the batter for a deep-fried food product, an area ratio (percentage) of voids in a cross-sectional area of a cooked batter layer is 6 to 25% when a cross section of the cooked batter layer derived from the batter for a deep-fried food product is observed with a scanning electron microscope.
(3) A processed food product for deep-frying, comprising a filling of an intended deep-fried food product, and a layer of the batter for a deep-fried food product according to the above (1) or (2) positioned outside the filling.
(4) The processed food product for deep-frying according to the above (3), which is in a frozen state.
(5) The processed food product for deep-frying according to the above (3) or (4), wherein in a deep-fried food product produced by deep-frying the processed food product for deep-frying, an area ratio (percentage) of voids in a cross-sectional area of a cooked batter layer is 6 to 25% when a cross section of the cooked batter layer derived from the batter for a deep-fried food product is observed with a scanning electron microscope.
(6) A method of producing a processed food product for deep-frying, comprising a battering step for treating a filling of an intended deep-fried food product with the batter for a deep-fried food product according to the above (1) or (2).
(7) The method according to the above (6), further comprising a freezing step performed after the battering step.
(8) A deep-fried food product, comprising a filling, and a cooked batter layer derived from the batter for a deep-fried food product according to the above (1) or (2), the cooked batter layer positioned outside the filling.
(9) The deep-fried food product according to the above (8), which is in a frozen state.
(10) The deep-fried food product according to the above (8) or (9), wherein an area ratio (percentage) of voids in a cross-sectional area of the cooked batter layer is 6 to 25% when a cross section of the cooked batter layer is observed with a scanning electron microscope.
(11) A method of producing a deep-fried food product, comprising a deep-frying step for deep-frying the processed food product for deep-frying according to any one of the above (3) to (5).
(12) The method according to the above (11), further comprising a freezing step performed after the deep-frying step.
(13) A deep-fried food product, comprising a filling, and a cooked batter layer derived from a batter for a deep-fried food product, the cooked batter layer positioned outside the filling,

wherein an area ratio (percentage) of voids in a cross-sectional area of the cooked batter layer is 6 to 25% when a cross section of the cooked batter layer is observed with a scanning electron microscope.

(14) The deep-fried food product according to the above (13), which is in a frozen state.

The eating texture, which includes crispness of a deep-fried coating and easiness in biting through a deep-fried food product, can be prevented from being degraded over time by using the batter of the present invention even when deep-fried food products are sold separately (in an open condition) or packed in bags or containers (in a sealed condition). In particular, in a deep-fried food product produced by using the batter of the present invention, moisture is less likely to be transferred from a filling (ingredients) to the deep-fried coating, and a crispy texture is thus maintained for a much longer time as compared to that of a conventional deep-fried food product with a coating. For example, when the deep-fried food product is packed in a container such as a tray and a bag after being deep-fried and left it to stand at ordinary temperatures, quality of the conventional product drops below a quality limit (significant degradation of the crispy texture) approximately in 3 hours. However, the deep-fried food product of the present invention can maintain its crispy texture at the same quality level as that of a deep-fried food product immediately after being deep-fried even after 4 hours. Further, even if the deep-fried food product of the present invention is reheated with a microwave after 4 hours, the deep-fried food product maintains better crispness than that of the conventional deep-fried food product with a coating without losing its crispness.

### BRIEF DESCRIPTION OF THE DRAWINGS

FIG. 1 is images of cooked batter layers of samples in test sections 2, 4, and 6 to 9 produced by observation with a scanning electron microscope and binarization.

### DETAILED DESCRIPTION OF THE INVENTION

A batter of the present invention contains a non-gelatinized starch, an emulsifier, an oil or fat, and water, wherein a mass ratio between the non-gelatinized starch and the water is in a specific range. To produce such a batter, ingredients including a non-gelatinized starch, an emulsifier, an oil or fat, and water in an individually prescribed amount to be mixed are charged into a container for mixing and mixed until the ingredients is in a batter state.

In the batter of the present invention, the content of the water relative to the non-gelatinized starch is 60 to 100 parts by mass, preferably 60 to 80 parts by mass, relative to 100 parts by mass of the non-gelatinized starch. In this case, it is necessary to consider that the above amount of water includes not only the amount of water charged into the container but also the amount of water contained in the other ingredients. Thus, when mixing an ingredient containing a significant amount of water, it is preferable that the content of the water relative to the non-gelatinized starch is adjusted after including a mass of the water contained in the ingredient. According to one embodiment of the present invention, to simplify the adjustment of the content of the water relative to the non-gelatinized starch, the batter of the present invention can consist of a non-gelatinized starch, an emulsifier, an oil or fat, and water.

The starch used in the present invention is not limited to a particular starch as long as the starch has a starch structure, and examples thereof include starches produced by refining various raw materials such as tapioca, corn, potatoes, sweet potatoes, rice, mung beans, and wheat, and processed starches produced by appropriately subjecting the above starches to a chemical processing. Further, the starch used for the present invention is a non-gelatinized starch that has not gone through a gelatinization process. According to a preferable embodiment of the present invention, a cornstarch that has not gone through a gelatinization process is used.

The content of the non-gelatinized starch in the batter of the present invention is not limited to a particular content. However, in consideration of the above-described mass ratio between the non-gelatinized starch and the water, a suitable content of the non-gelatinized starch is, for example, approximately 30 to 55% by mass, preferably 35 to 52% by mass, relative to the mass of the batter.

The oil or fat used in the present invention may be any edible oils or fats and may be any of vegetable oils or fats, animal oils or fats, and processed vegetable or animal oils or fats, for example. Further, the oil or fat used in the present invention may be an oil or fat in a liquid form when coating the filling with the batter of the present invention, and may be liquid oils or fats or melted oils or fats prepared by heating solid oils or fats which are solid at ordinary temperatures. Examples of such oils or fats include rapeseed oil, soybean oil, corn oil, sunflower oil, sesame oil, safflower oil, cottonseed oil, rice bran oil, peanut oil, olive oil, palm oil, coconut oil, cacao butter, butter, margarine, shortening, beef tallow, and lard.

The content of the oil or fat in the batter of the present invention is not limited to a particular content and can be appropriately determined according to kinds of intended deep-fried food products. For example, an appropriate content of the oil or fat in the batter of the present invention is approximately 10 to 40% by mass, preferably 15 to 30% by mass, more preferably 15 to 25% by mass, relative to the mass of the batter.

The emulsifier used in the present invention may be any emulsifiers for food products and may be any of natural emulsifiers such as lecithin, saponin, and casein sodium and synthesized emulsifiers such as glycerin fatty acid ester, sorbitan fatty acid ester, propylene glycol fatty acid ester, and sucrose fatty acid ester, for example. According to a preferable embodiment of the present invention, the emulsifier used in the present invention is polyglycerin fatty acid ester, more preferably decaglycerin stearate (Poem J-0081HV).

The content of the emulsifier in the batter of the present invention is not limited to a particular content and can be determined according to the content of oil or fat and water so that these ingredients are well emulsified. For example, the content of the emulsifier in the batter of the present invention is approximately 0.1 to 5% by mass, preferably 0.5 to 2% by mass, more preferably 0.5 to 1.5% by mass, relative to the mass of the batter.

The batter of the present invention may contain other components in addition to the above essential components without losing effects of the present invention as well as to demonstrate other effects. Examples of the other components include seasonings such as various grain flours, various starches, common salt, sugar, and amino acids, coloring matters such as β-carotene, spices, acid condiments, pH adjusters, saccharides, dietary fibers, and animal or vegetable protein materials. The amount of the other components to be mixed can be appropriately determined according to kinds of the components. However, a total amount of the other components to be mixed is preferably 30% by mass or less. In this case, when the other components contain a significant amount of water or a non-gelatinized starch, it is preferable that the content of the water relative to the non-gelatinized starch is adjusted after including a mass of the water and the non-gelatinized starch contained in the other components.

A processed food product for deep-frying of the present invention comprises a filling of an intended deep-fried food product, and a layer of the batter of the present invention positioned outside the filling. The “processed food product for deep-frying” in the present invention refers to a food product that has been processed to be deep-fried and has not yet been deep-fried. On the other hand, the “deep-fried food product” in the present invention refers to a food product produced by deep-frying the processed food product for deep-frying.

A processed food product for deep-frying of the present invention can be produced by a method comprising a battering step for treating a filling of an intended deep-fried food product with the batter of the present invention. For example, by adhering at least the batter of the present invention to ingredients of an intended deep-fried food product, preferably by coating the surface of the ingredients with the batter of the present invention, the processed food product for deep-frying of the present invention can be produced.

Such a processed food product for deep-frying includes, for example, fried food such as croquettes, deep-fried breaded pork cutlets, deep-fried prawns, and deep-fried fishes, before being deep-fried, which are prepared by adhering the batter of the present invention and a coating material to a filling; and tempura and deep-fried food before being deep-fried on which a coating layer is directly formed using the batter of the present invention. As the coating material, bread crumbs are typically used. However, coating materials other than the bread crumbs can also be used. As a substitute for the bread crumbs, expanded products mainly made of crackers, cornflakes, and grains and produced by extrusion molding, wheat-gluten breads, freeze-dried tofu, and bean curd lees have been known. These materials can be used as they are or by grinding or crushing to an appropriate size.

For example, when a croquette before being deep-fried is produced as a processed food product for deep-frying of the present invention, vegetables such as potatoes and onions and meats such as beef and pork are mixed and kneaded to form a filling, and the batter of the present invention is uniformly adhered to the surface of the filling and bread crumbs are subsequently adhered thereto, thereby producing the croquette before being deep-fried. Alternatively, primary bread crumbs, the batter of the present invention, and secondary bread crumbs are uniformly adhered to the filling in the mentioned order. Further, in such a method, by changing the filling to a material such as prawns, pork, and fishes, deep-fried prawns, deep-fried breaded pork cutlets, deep-fried fishes, and the like, before being deep-fried can be produced.

The processed food product for deep-frying of the present invention may be deep-fried immediately after being produced to produce a deep-fried food product, or may be deep-fried after being kept in a freezer or a cold room to produce a deep-fried food product. A freezing or cooling method is not limited to a particular method, and a usual method can be used. For example, in a case of being kept in a freezer, a method in which a processed food product for deep-frying is frozen in accordance with a freezing method such as an air blast freezing method, a semi-air blast freezing method, a contact freezing method and then kept at −18° C. or lower, or a method in which a processed food product for deep-frying is frozen by spraying liquefied nitrogen or liquefied carbonic acid and then kept at −18° C. or lower can be used. In particular, the freezing method is preferably performed by quick-freezing at around −35° C.

The deep-fried food product of the present invention includes a filling and a cooked batter layer derived from the batter for a deep-fried food product according to the above (1) or (2) and positioned outside the filling. Such a deep-fried food product can be produced by deep-frying the processed food product for deep-frying of the present invention. For example, deep-frying can be performed by deep-frying to cook a processed food product for deep-frying immediately after being produced or a processed food product for deep-frying that has been kept in a freezer or a cold room after being produced, in an edible oil or fat at 140 to 200° C. for 60 to 600 seconds.

The deep-fried food product produced in the above manner may be served on a dining table immediately after being produced, may be served on a dining table after being kept in a freezer or a cold room and then cooked again with a microwave or the like, or may be served on a dining table after being kept at room temperature. A method of freezing or cooling the deep-fried food product of the present invention is the same as the above-described method used for the processed food product for deep-frying of the present invention.

Further, the deep-fried food product of the present invention may be kept at 30 to 75° C. after being produced. A method of keeping a deep-fried food product at the above range of temperatures is not limited to a particular method. However, an example thereof includes a method in which a deep-fried food product is kept in a heater or a warmer such as a hot warmer.

In the study of a structural characteristic of the deep-fried food product of the present invention, it is found that an area ratio (percentage) of voids in a cross-sectional area of a cooked batter layer is in a range of 6 to 25% when a cross section of the cooked batter layer included in the deep-fried food product is observed with a scanning electron microscope. This characteristic is not found in the conventional product, and it is considered that this characteristic directly connects with a lasting crispy eating texture of a coating.

Accordingly, another aspect of the present invention provides a deep-fried food product comprising a filling, and a cooked batter layer derived from a batter for a deep-fried food product, the cooked batter layer positioned outside the filling, in which an area ratio (percentage) of voids in a cross-sectional area of a cooked batter layer is 6 to 25% when a cross section of the cooked batter layer is observed with a scanning electron microscope. Details of the observation made with this scanning electron microscope are described in the following Example.

### EXAMPLE

The present invention will be specifically described with reference to Example below. However, the present invention is not limited to the following Example.

### Example 1: Studies Made in Regard to a Batter Composition that Gives a Crispy Eating Texture to a Coating

### (1) Production of Sample Batters

Ingredients were put together in accordance with a list of an amount to be mixed shown in Table 1 below, and mixed with a handheld blender (manufactured by Braun GmbH, model number: MQ500) with an aim to turn a mixture into a batter state.

TABLE 1
Mass (g) and percentage (% by mass) of ingredients used for each test section

| | | | Test section | | | | | | | | | | | |
|---|---|---|---|---|---|---|---|---|---|---|---|---|---|---|
| | | Ingre- | 1 | | 2 | | 3 | | 4 | | 5 | | 6 | |
| Ingredient | | dient | Starch:Water = | | Starch:Water = | | Starch:Water = | | Starch:Water = | | Starch:Water = | | Starch:Water = | |
| (product | Company | (general | 5:2 | | 5:3 | | 5:4 | | 5:5 | | 5:8 | | 5:10 | |
| name) | name | name) | Mass | Percentage | Mass | Percentage | Mass | Percentage | Mass | Percentage | Mass | Percentage | Mass | Percentage |
| Cornstarch | Sanwa | Starch | 286.0 | 56.6 | 250.0 | 49.5 | 222.0 | 44.0 | 200.0 | 39.6 | 154.0 | 30.5 | 135.0 | 26.5 |
| Y | Starch Co., | | | | | | | | | | | | | |
| | Ltd. | | | | | | | | | | | | | |
| Poem | RIKEN | Emul- | 5.0 | 1.0 | 5.0 | 1.0 | 5.0 | 1.0 | 5.0 | 1.0 | 5.0 | 1.0 | 5.0 | 1.0 |
| J0081HV | VITAMIN | sifier | | | | | | | | | | | | |
| | CO., LTD. | | | | | | | | | | | | | |
| Soybean | The Nisshin | Oil or | 100.0 | 19.8 | 100.0 | 19.8 | 100.0 | 19.8 | 100.0 | 19.8 | 100.0 | 19.8 | 100.0 | 19.6 |
| essential | OilliO | fat | | | | | | | | | | | | |
| rape oil | Group, Ltd. | | | | | | | | | | | | | |
| Water | | | 114.5 | 22.7 | 150.0 | 29.7 | 177.5 | 35.2 | 200.0 | 39.6 | 246.5 | 48.8 | 270.0 | 52.9 |
| Total | | | 505.5 | 100.0 | 505.0 | 100.0 | 504.5 | 100.0 | 505.0 | 100.0 | 505.5 | 100.0 | 510.0 | 100.0 |

| | | | Test section | | | | | |
|---|---|---|---|---|---|---|---|---|
| | | | 7 | | 8 | | 9 | |
| | | | Starch:Water = | | Starch:Water = | | Starch:Water = | |
| Ingredient (product | | Ingredient (general | 1:6 | | 3:7 | | 1:3.6 | |
| name) | Company name | name) | Mass | Percentage | Mass | Percentage | Mass | Percentage |
| Soybean essential | The Nisshin OilliO Group, Ltd. | Oil or fat | 200.0 | 36.4 | 210.0 | 35.7 | 160.0 | 28.4 |
| rape oil | | | | | | | | |
| Water | | | 250.0 | 45.5 | 252.0 | 42.8 | 300.0 | 53.3 |
| National Fregex | Ingredion Japan K. K. | Modified starch | 40.0 | 7.3 | | | | |
| Pineflow | Matsutani Chemical Industry | Dextrin | 20.0 | 3.6 | | | | |
| | Co., Ltd. | | | | | | | |
| Stabilose 1000 | Matsutani Chemical Industry | Starch | | | 108.0 | 18.3 | | |
| | Co., Ltd. | | | | | | | |
| New Fujipro HP | FUJI OIL CO., LTD. | Soybean protein | 40.0 | 7.3 | 18.0 | 3.1 | | |
| Pinebake CC | Matsutani Chemical Industry | Modified starch | | | | | 80.0 | 14.2 |
| | Co., Ltd. | | | | | | | |
| N-Creamer 46 | Ingredion Japan K. K. | Modified starch | | | | | 3.0 | 0.5 |
| Sol-p 4000H | The Nisshin OilliO Group, Ltd. | Soybean protein | | | | | 20.0 | 3.6 |
| Monat Gum OB | CP Kelco | Xanthan gum | | | 0.8 | 0.1 | | |
| Total | | | 550.0 | 100.0 | 588.1 | 100.0 | 563.0 | 100.0 |

| | | | Test section | | | | | | | | | |
|---|---|---|---|---|---|---|---|---|---|---|---|---|
| | | | | | 11 | | | | | | | |
| Ingre- | | | | | The white | | 12 | | | | | |
| dient | | | 10 | | of an egg | | Soybean protein | | 13 | | 14 | |
| (product | | Ingredient | Wheat flour | | (protein) | | (protein) | | Gluten (protein) | | Gelatinized starch | |
| name) | Company name | (general name) | Mass | Percentage | Mass | Percentage | Mass | Percentage | Mass | Percentage | Mass | Percentage |
| Poem | RIKEN VITAMIN | Emulsifier | 5.0 | 1.0 | 5.0 | 1.0 | 5.0 | 1.0 | 5.0 | 1.0 | 5.0 | 1.0 |
| J0081HV | CO., LTD. | | | | | | | | | | | |
| Soybean | The Nisshin | Oil or fat | 100.0 | 19.8 | 100.0 | 19.8 | 100.0 | 19.8 | 100.0 | 19.8 | 100.0 | 19.8 |
| essential rape | OilliO Group, | | | | | | | | | | | |
| oil | Ltd. | | | | | | | | | | | |
| Water | | | 150.0 | 29.7 | 150.0 | 29.7 | 150.0 | 29.7 | 150.0 | 29.7 | 150.0 | 29.7 |
| Wheat flour | Nisshin Seifun | Weak flour | 250.0 | 49.5 | | | | | | | | |
| (violet) | Group Inc. | | | | | | | | | | | |
| Dried | Matsuda Sangyo | Dried albumen | | | 250.0 | 49.5 | | | | | | |
| albumen EPS | Co., Ltd. | | | | | | | | | | | |
| Matsunorin | Matsutani | α Gelatinized | | | | | | | | | 250.0 | 49.5 |
| M22 | Chemical | starch | | | | | | | | | | |
| | Industry Co., | | | | | | | | | | | |
| | Ltd. | | | | | | | | | | | |
| Sol-p 4000H | The Nisshin | Soybean | | | | | 250.0 | 49.5 | | | | |
| | OilliO Group, | protein | | | | | | | | | | |
| | Ltd. | | | | | | | | | | | |
| B Powder glu | Showa Sangyo | Wheat protein | | | | | | | 250.0 | 49.5 | | |
| | Co., Ltd. | | | | | | | | | | | |
| Total | | | 505.0 | 100.0 | 505.0 | 100.0 | 505.0 | 100.0 | 505.0 | 100.0 | 505.0 | 100.0 |

Test section 7: mixed as described in Japanese Patent Laid-Open No. 9-206016
Test section 8: mixed as described in Japanese Patent Laid-Open No. 7-155127
Test section 9: mixed as described in Japanese Patent Laid-Open No. 2011-244720

The samples in test sections 2 to 9 turned into a batter state after 9 minutes of mixing. On the other hand, the samples in test sections 1 and 10 to 14 turned out to have no fluidity even though they were mixed and thus failed to reach a batter state. For that reason, it is considered that a non-gelatinized starch is preferably used instead of using a material containing a protein and a gluten or a gelatinized starch. Further, it is clear that when the amount of water is too small relative to the amount of the non-gelatinized starch, the resultant mixture fails to reach a batter state.

The samples in test sections 2 to 9 were used for the following experiment.

### (2) Production of Croquettes Using Sample Batters

The ingredients including 70.0% by mass of potatoes, 18.0% by mass of minced beef, 5.0% by mass of onions, and 7.0% by mass of seasonings were used to form a filling of a croquette. First, the potatoes were steamed and peeled to mash them up, and mashed potatoes were then cooled down to room temperature. Minced beef and chopped onions were fried together, and seasonings were added therein. The mashed potatoes were mixed with the above minced beef and onions, which was shaped to prepare fillings of a croquette.

The surface of 52 g of the fillings prepared as above were each covered with 0.7 g of dried bread crumbs as a dusting powder, then coated with 14.0 g of each sample batter, and covered with 13.0 g of raw bread crumbs. Resultant croquettes before being deep-fried were quick-frozen in a freezer at approximately −35° C.

The frozen croquettes before being deep-fried produced in the above manner were deep-fried at 175° C. for 6 minutes and 30 seconds. The deep-fried croquettes were allowed to cool for approximately 5 minutes. Two croquettes were packed in Food pack SA-20 (a transparent container with a lid made of a biaxially oriented polystyrene sheet having a size of 130 mm length×201 mm width×49 mm height) manufactured by FP Corporation with a lid on and left to stand at ordinary temperatures for approximately 4 hours. The croquettes prepared in the above manner were used as samples for a sensory evaluation. As samples to be observed with an electron microscope, deep-fried croquettes were used.

### (3) Sensory Evaluation

A sensory evaluation was conducted on sample croquettes produced in the above (2) by three professional panelists. Items to be evaluated and evaluation criteria are as follows. In the following items, the product immediately after being deep-fried was considered to have a full mark of 5.

### (i) Crispness of Coating:

1 point: not crispy—(3 point or more: acceptable)—5 points: crispy

### (ii) Resilience of Coating (Easiness in Biting Through):

1 point: hard to bite through—(3 point or more: acceptable)—5 points: easy to bite through
(iii) Weakening (Softening) of Coating:
1 point: weakened—(3 point or more: acceptable)—5 points: not weakened

### (iv) Oiliness of Coating:

1 point: oily—(3 point or more: acceptable)—5 points: not oily

### (v) Overall Evaluation:

A: Quality of the coating is very good
B: Quality of the coating is good
C: Quality of the coating is not acceptable
D: Quality of the coating is not acceptable at all
(4) Observation and Measurement with Electron Microscope

A deep-fried croquette was quick-frozen in a freezer at approximately −35° C., which was cut into a 1 cm square with a cutter to prepare a croquette piece with a coating. The prepared croquette piece was subjected to desiccation by vacuum freeze drying and then deoiling by dipping the croquette piece into an acetone solvent. Next, gold deposition was performed on the desiccated and deoiled croquette piece by Ion coater IB-3 (manufactured by Eiko Co., Ltd.), and the resultant croquette piece was observed with a scanning electron microscope (ABT-60 manufactured by TOPCON CORPORATION) to produce a 50-times enlarged image of a cross section of a batter layer of the coating.

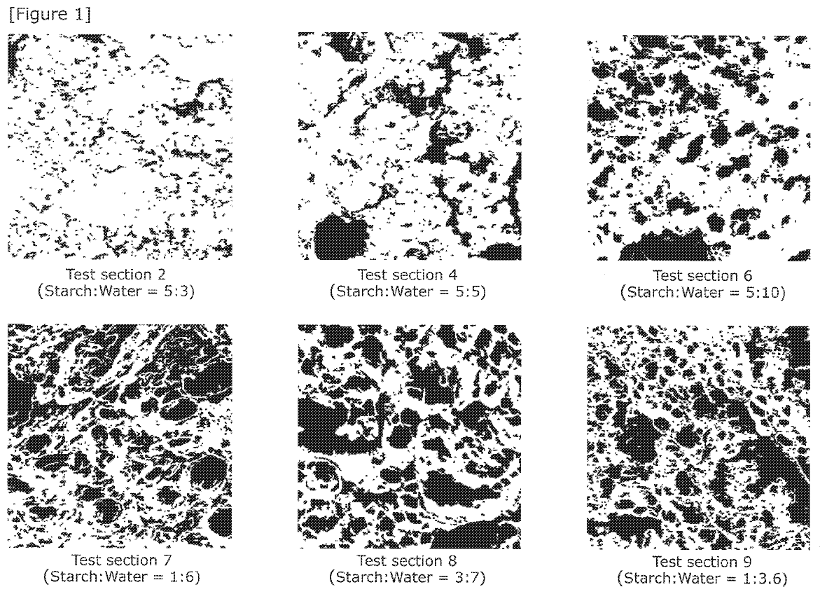

The produced image was analyzed with an image analysis software called ImageJ. Specifically, four to six regions each being a 200 μm square and showing a typical structure were selected from the image of the cross section of the batter layer. Next, each region was binarized using “Default” as a parameter of threshold value settings. Further, the threshold value was adjusted so that void portions were shown in black and solid portions were shown in white similarly to the image of the regions before the binarization. A typical image of each test section after the binarization is shown in FIG. 1. A percentage of areas in black after the binarization relative to a total area of regions was calculated and recorded as a percentage of voids. Further, an average value of the percentage of voids in each region was determined as an average percentage of voids.

### (5) Results and Discussion

The results of the sensory evaluation as well as a mass ratio between the starch and the water in the batter used for each sample are shown in Table 2 below.

TABLE 2
Sensory evaluation results of samples that have been deep-fried,
then packed in a transparent pack with a lid on, and
left to stand at ordinary temperatures for approximately 4 hours

| | | | | Weakening | | |
|---|---|---|---|---|---|---|
| Test | Starch:Water | Crispness | Resilience | (softening) of | Oiliness | Overall |
| section | (mass ratio) | of coating | of coating | coating | of coating | evaluation |
| 2 | 5:3 | 4.5 | 3.5 | 4.0 | 3.8 | A |
| 3 | 5:4 | 4.0 | 3.1 | 3.6 | 3.6 | A |
| 4 | 5:5 | 3.0 | — | — | — | B |
| 5 | 5:8 | 2.4 | 2.5 | 2.4 | 3.0 | D |
| 6 | 5:10 | 2.0 | — | — | — | D |
| 7 | 1:6 | 2.0 | 1.9 | 1.1 | 1.8 | D |
| 8 | 3:7 | 2.3 | 2.0 | 1.4 | 1.6 | D |
| 9 | 1:3.6 | 2.0 | 1.9 | 1.1 | 1.6 | D |

Test section 7: mixed as described in Japanese Patent Laid-Open No. 9-206016
Test section 8: mixed as described in Japanese Patent Laid-Open No. 7-155127
Test section 9: mixed as described in Japanese Patent Laid-Open No. 2011-244720

As is clear from Table 2, the samples each having a mass ratio between the starch and the water (starch:water) in the batter of 5:3, 5:4, or 5:5 show good evaluation results, and, above all, the samples each having the above mass ratio of 5:3 or 5:4 show particularly good evaluation results. Therefore, it is considered that a preferable mass ratio of water to starch in the batter is 60 to 100 parts by mass of water relative to 100 parts by mass of starch, more preferably 60 to 80 parts by mass of water relative to 100 parts by mass of starch.

Next, measured values of the percentage of voids obtained by the observation with an electron microscope as well as a mass ratio between the starch and the water in the batter used for each sample are shown in Table 3.

TABLE 3
Percentage of voids of deep-fried samples obtained by observation with
electron microscope

| | Starch:Water | Average percentage of | |
|---|---|---|---|
| Test section | (mass ratio) | voids (%) | Standard deviation |
| 2 | 5:3 | 9.2 | 2.8 |
| 4 | 5:5 | 21.7 | 4.8 |
| 6 | 5:10 | 30.9 | 5.5 |
| 7 | 1:6 | 40.2 | 7.9 |
| 8 | 3:7 | 40.4 | 6.6 |
| 9 | 1:3.6 | 42.3 | 5.4 |

Test section 7: mixed as described in Japanese Patent Laid-Open No. 9-206016
Test section 8: mixed as described in Japanese Patent Laid-Open No. 7-155127
Test section 9: mixed as described in Japanese Patent Laid-Open No. 2011-244720

As is clear from Table 3, the samples showing good evaluation results in the sensory evaluation (samples having a mass ratio between the starch and the water (starch:water) in the batter of 5:3 or 5:5) show a percentage of voids of 9.2% (standard deviation of 2.8) and 21.7% (standard deviation of 4.8), respectively. Based on a comparison made between these values and the percentage of voids of the other samples, it is considered that a value of the percentage of voids for a deep-fried food product having good sensory evaluation results is approximately 6% to 25%.

(6) Sensory Evaluation after being Kept while Heating

The samples each having a mass ratio between the starch and the water (starch:water) in the batter of 5:3 or 5:4 were deep-fried and then kept under conditions of a temperature of 70° C. and a humidity of 20% for 4 hours immediately after being deep-fried, and the sensory evaluation was conducted in the same manner as in the above (3). The results are shown in Table 4 below.

TABLE 4
Sensory evaluation results of samples that have been deep-fried and then
kept under warm conditions of a temperature of 70° C. and a humidity of 20% for 4
hours

| | | | | Weakening | | |
|---|---|---|---|---|---|---|
| Test | Starch:Water | Crispness | Resilience | (softening) of | Oiliness of | Overall |
| section | (mass ratio) | of coating | of coating | coating | coating | evaluation |
| 2 | 5:3 | 5.0 | 4.5 | 4.6 | 4.3 | A |
| 3 | 5:4 | 4.6 | 4.0 | 4.2 | 4.0 | A |

As is clear from Table 4, although the samples each having a mass ratio between the starch and the water (starch:water) in the batter of 5:3 or 5:4 were kept under conditions of a temperature of 70° C. and a humidity of 20%, these samples show good sensory evaluation results. Therefore, it is confirmed that an excellent eating texture can be maintained even when a deep-fried food product is eaten after being kept in a warming case.

1. A batter for a deep-fried food product, comprising a nongelatinized starch, an emulsifier, an oil or fat, and water, wherein a content of the water relative to the non-gelatinized starch is 60 to 100 parts by mass relative to 100 parts by mass of the nongelatinized starch.

2. The batter for a deep-fried food product according to claim 1,
wherein in a deep-fried food product produced by deep-frying a processed food product for deep-frying containing the batter for a deep-fried food product, an area ratio (percentage) of voids in a cross-sectional area of a cooked batter layer is 6 to 25% when a cross section of the cooked batter layer derived from the batter for a deep-fried food product is observed with a scanning electron microscope.

3. A processed food product for deep-frying, comprising a filling of an intended deep-fried food product, and a layer of the batter for a deep-fried food product according to claim 1 positioned outside the filling.

4. The processed food product for deep-frying according to claim 3, which is in a frozen state.

5. The processed food product for deep-frying according to claim 3,
wherein in a deep-fried food product produced by deep-frying the processed food product for deep-frying, an area ratio (percentage) of voids in a cross-sectional area of a cooked batter layer is 6 to 25% when a cross section of the cooked batter layer derived from the batter for a deep-fried food product is observed with a scanning electron microscope.

6. A method of producing a processed food product for deep-frying, comprising a battering step for treating a filling of an intended deep-fried food product with the batter for a deep-fried food product according to claim 1.

7. The method according to claim 6, further comprising a freezing step performed after the battering step.

8. A deep-fried food product, comprising a filling, and a cooked batter layer derived from the batter for a deep-fried food product according to claim 1, the cooked batter layer positioned outside the filling.

9: The deep-fried food product according to claim 8, which is in a frozen state.

10. The deep-fried food product according to claim 8,
wherein an area ratio (percentage) of voids in a cross-sectional area of the cooked batter layer is 6 to 25% when a cross section of the cooked batter layer is observed with a scanning electron microscope.

11. A method of producing a deep-fried food product, comprising a deep-frying step for deep-frying the processed food product for deep-frying according to claim 3.

12. The method according to claim 11, further comprising a freezing step performed after the deep-frying step.

13. A deep-fried food product, comprising a filling, and a cooked batter layer derived from a batter for a deep-fried food product, the cooked batter layer positioned outside the filling,
wherein an area ratio (percentage) of voids in a cross sectional area of the cooked batter layer is 6 to 25% when a cross section of the cooked batter layer is observed with a scanning electron microscope.

14. The deep-fried food product according to claim 13, which is in a frozen state.

15. A processed food product for deep-frying, comprising a filling of an intended deep-fried food product, and a layer of the batter for a deep-fried food product according to claim 2 positioned outside the filling.

16. The processed food product for deep-frying according to claim 15,
wherein in a deep-fried food product produced by deep-frying the processed food product for deep-frying, an area ratio (percentage) of voids in a cross-sectional area of a cooked batter layer is 6 to 25% when a cross section of the cooked batter layer derived from the batter for a deep-fried food product is observed with a scanning electron microscope.

17. A method of producing a processed food product for deep-frying, comprising a battering step for treating a filling of an intended deep-fried food product with the batter for a deep-fried food product according to claim 2.

18. The method according to claim 17, further comprising a freezing step performed after the battering step.

19. A deep-fried food product, comprising a filling, and a cooked batter layer derived from the batter for a deep-fried food product according to claim 2, the cooked batter layer positioned outside the filling.

20. The deep-fried food product according to claim 19,
wherein an area ratio (percentage) of voids in a cross-sectional area of the cooked batter layer is 6 to 25% when a cross section of the cooked batter layer is observed with a scanning electron microscope.
